(19) United States
(12) Patent Application Publication
(10) Pub. No.: US 2005/0198612 A1
(43) Pub. Date: Sep. 8, 2005

(54) Unified application, user interface and data linking

(76) Inventor: Andy Gonzalez, Milpitas, CA (US)

Correspondence Address: PERKINS COIE LLP, P.O. BOX 2168, MENLO PARK, CA, 94026, US

(21) Appl. No.: 10/796,422

(22) Filed: Mar. 8, 2004

(51) Int. Cl. G06F 9/44

(52) U.S. Cl. 717/101

(57) ABSTRACT

A graphical user-interface enabling control of multiple applications: 1) create a unified graphical user-interface for enabling a plurality of projects, 2) pre-determine a series of computer-implemented tasks for each project using the unified graphical user-interface, 3) integrate and synchronize the execution of the various disparate computer application programs through the unified graphical user-interface for performing the tasks in the given project, 4) synchronize data for use in different tasks within the project and across related projects, 5) synchronize tasks within a project and across related projects, and 6) provide reports on project milestones and task results.

### CROSS-REFERENCE TO RELATED APPLICATIONS

This application claims the benefit of Andy Gonzalez's U.S. Provisional Patent Application entitled “UNIFIED APPLICATION, USER INTERFACE AND DATA LINKING”, and filed on Feb. 17, 2004, and which is hereby incorporated by reference in its entirety.

### TECHNICAL FIELD

The present invention is directed to the field of project development and management, and more specifically to aspects of a computer-implemented unified approach to defining and performing projects using one or more computer application programs.

### BACKGROUND

To perform tasks associated with a given project using a computer involves using one or more computer application programs that are independent of each other. Further, the performance of such tasks involves using data from disparate sources. Each of such computer application programs and data sources has its own independent user-interface. Such computer application programs and data sources operate independently of each other and do not share data with each other. In the context of project development and management of projects, it is up to the user who has been tasked to work on the project to manually perform the following: 1) devise a course of action by defining specific tasks for the project, 2) synchronize data for use in different tasks within the project, 3) synchronize tasks within a project and across related projects, and 4) provide reports on project milestones.

In view of the foregoing, a computer-implemented unified approach to defining, managing and performing projects using one or more computer application programs, is needed.

### BRIEF DESCRIPTION OF THE DRAWINGS

FIG. 1A is a high-level network diagram showing aspects of a computerized environment in which the facility operates, according to certain embodiments.

FIG. 1B is a block diagram showing some of the components typically incorporated in at least some of the computer systems and other devices on which the facility executes.

FIG. 2 is a high-level flow diagram that shows some steps performed by the facility.

FIG. 3 is a block diagram that describes some of the mechanisms that are used in creating a unified graphical user-interface.

FIGS. 4A, 4B, 4C, 4D, and 4E are block diagrams that illustrate some of the features of a unified graphical user-interface, according to certain embodiments.

FIG. 5A is a block diagram that illustrates a unified graphical user-interface, according to certain embodiments.

FIGS. 5B, 5C, 5D, and 5E are block diagrams that illustrate the creation of a task by using a unified graphical user-interface, according to certain embodiments.

FIGS. 6A, 6B, and 6C, are block diagrams that illustrate how data in application programs can be updated using a unified graphical user-interface, according to certain embodiments.

FIGS. 7A, 7B, 7C, 7D, and 7E are block diagrams that illustrate the creation of new data fields associated with application programs using a unified graphical user-interface, according to certain embodiments.

FIG. 8 is a block diagram of a computer system in accordance with one embodiment of the present invention.

FIG. 9 is a block diagram of a computer system in accordance with a distributed architecture aspect of the present invention.

### DETAILED DESCRIPTION

According to certain embodiments, the facility enables a plurality of projects by performing some or all of the following functions: 1) create a unified graphical user-interface for enabling a plurality of projects, 2) pre-determine a series of computer-implemented tasks for each project using the unified graphical user-interface, 3) integrate and synchronize the execution of the various disparate computer application programs through the unified graphical user-interface for performing the tasks in the given project, 4) synchronize data for use in different tasks within the project and across related projects, 5) synchronize tasks within a project and across related projects, and 6) provide reports on project milestones and task results. Thus, the tasks within a project and across related projects have a unified view of the project data.

According to certain embodiments, the unified graphical user-interface displays one or more data fields depending on what task has been selected for display and performance. The data in such data fields are used for performing the task that has been selected using the unified graphical user-interface. Such data fields may appear as GUI boxes in the unified graphical user-interface. Such GUI boxes can be multi-purpose. For example, the GUI boxes can be used for searching by inputting a key-word search term in the GUI box. In addition to using the GUI boxes to perform searches, the same GUI boxes can be used for inputting data or for modifying existing data. Further, the same GUI boxes can have pull-down menus for listing data or for listing options and/or functions.

Further, according to certain embodiments, the unified graphical user-interface is adapted for automatically executing one or more computer application programs for performing the task that has been selected using the unified graphical user-interface. The computer application programs may either be pre-existing commercially available third party application programs or custom-made application programs or a combination of both.

According to certain embodiments, by using the unified graphical user-interface, new projects and associated tasks can be dynamically created and added to the existing projects and tasks. Further, the unified graphical user-interface is adapted to support the display and performance of stand-alone tasks that are not necessarily associated with any project.

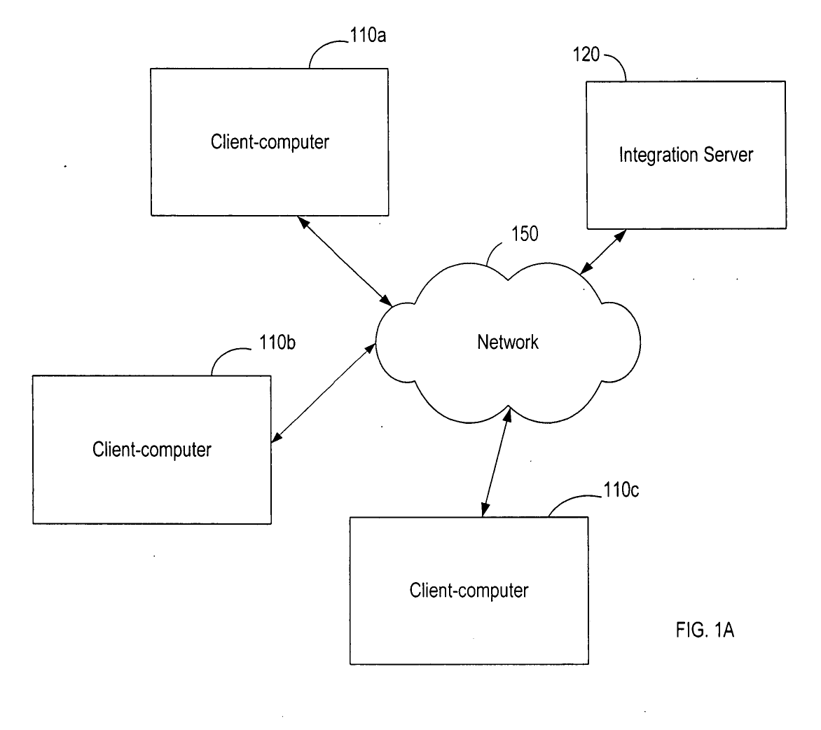

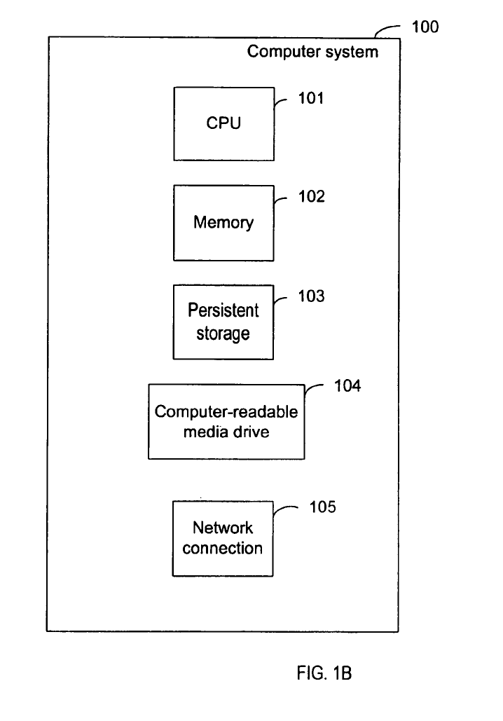

FIG. 1A is a high-level network diagram showing aspects of a typical hardware environment in which the facility operates. FIG. 1A shows a plurality of client computers 110a-c, an integration server system 120 and a network 150. The unified graphical user-interface (not shown in FIG. 1A) is displayed on client computers 110a-c. There may be more than one integration server.

The facility (not shown) enables a plurality of projects as described herein. In certain embodiments, the functions of the facility are performed with the aid of one or more other computer systems, such as integration server system 120. Components of the facility may reside on and/or execute on any combination of these computer systems, and data used or produced or otherwise associated with components of the facility may similarly reside on any combination of these computer systems.

The computer systems shown in FIG. 1A are connected via network 150, which may use a variety of different networking technologies, including wired, guided or line-of-sight optical, and radio frequency networking. In some embodiments, the network includes the public switched telephone network. Network connections established via the network may be fully-persistent, session-based, or intermittent, such as packet-based. While the facility typically operates in an environment such as is shown in FIG. 1A and described above, those skilled in the art will appreciate the facility may also operate in a wide variety of other environments.

FIG. 1B is a block diagram showing some of the components typically incorporated in at least some of the computer systems and other devices on which the facility executes, including some or all of the server and client computer systems shown in FIG. 1A. These computer systems and devices 100 may include one or more central processing units (“CPUs”) 101 for executing computer programs; a computer memory 102 for storing programs and data—including data structures—while they are being used; a persistent storage device 103, such as a hard drive, for persistently storing programs and data; a computer-readable media drive 104, such as a CD-ROM drive, for reading programs and data stored on a computer-readable medium; and a network connection 105 for connecting the computer system to other computer systems, such as via the Internet, to exchange programs and/or data—including data structures. While computer systems configured as described above are typically used to support the operation of the facility, those skilled in the art will appreciate that the facility may be implemented using devices of various types and configurations, and having various components.

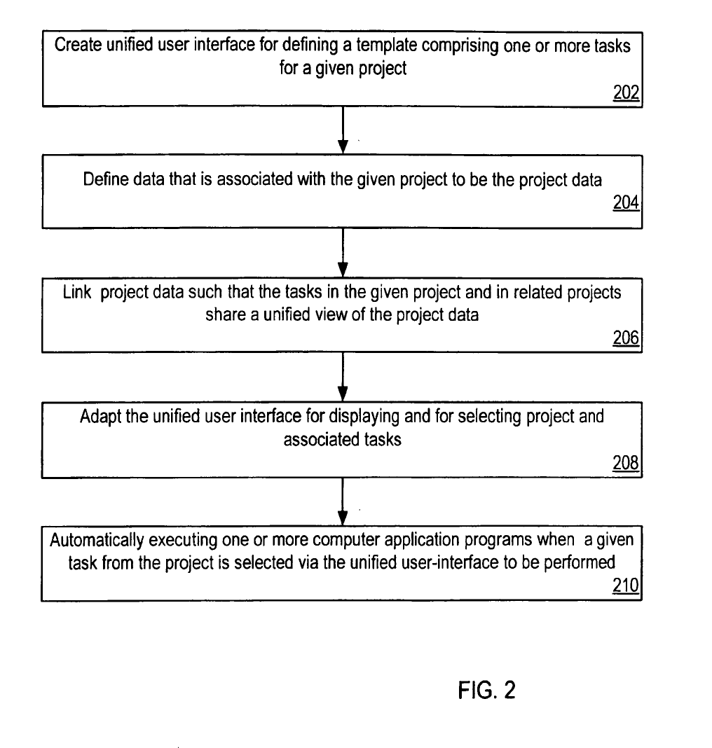

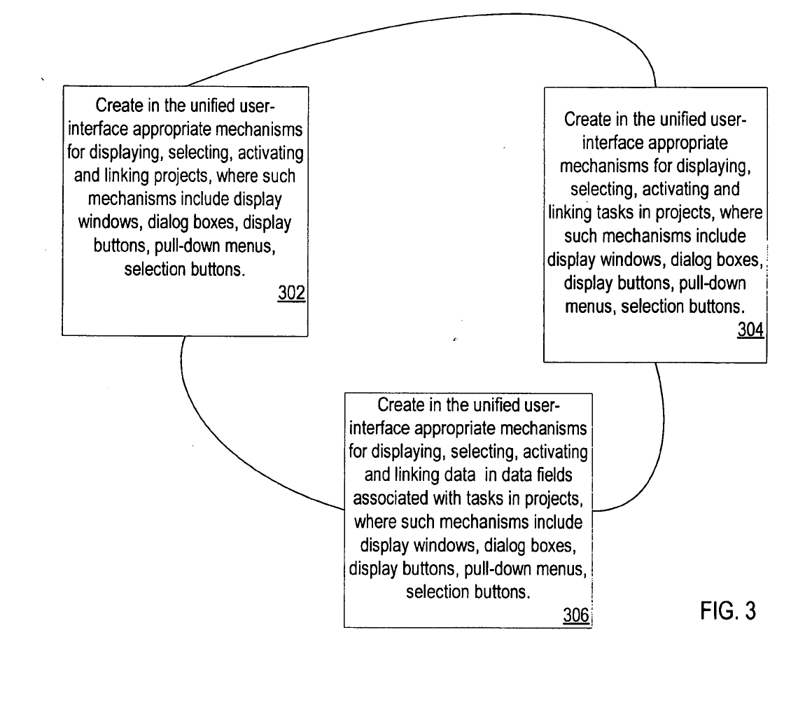

FIG. 2 is a high-level flow diagram that shows some steps typically performed by the facility in order to develop, manage, and/or perform projects using a unified approach. At block 202, the facility creates a unified graphical user-interface for defining a template comprising one or more tasks for a given project. The tasks can pre-determined for the given project. Tasks can also be created extemporaneously while working on a given project. Tasks can also be stand-alone, i.e., not associated with any particular project. The creation of the unified graphical user-interface is described in greater detail herein with reference to FIG. 3.

At block 204, the facility defines data that is associated with the given project to be project data. For example, the data that is used in performing a selected task within the given project is defined to be project data for that particular project. Further, any new data that is generated as a result of performing a selected task within the given project is defined to be project data for that particular project. Any received data that is received in response to performing a selected task within the given project is also defined to be project data for that particular project.

At block 206, the facility links the project data across tasks within the project and across related projects so that such tasks and associated computer application programs share a unified view of the project data. Thus, any updates or modifications to the project are visible and accessible to such tasks.

At block 208, the unified graphical user-interface is adapted for displaying and for selecting a given project and associated tasks. At block 210, the facility automatically executes one or more computer application programs when a given task is selected via the unified graphical user-interface to be performed.

FIG. 3 is a block diagram that describes some of the mechanisms that are used in creating the unified graphical user-interface. The actions that are described in FIG. 3 are not restricted to being performed in the order that they are described. At block 302, the facility creates in the unified graphical user-interface appropriate mechanisms for displaying, selecting, activating and linking projects, where such mechanisms can include display windows, dialog boxes, display buttons, pull-down menus, and selection buttons. At block 304, the facility creates in the unified graphical user-interface appropriate mechanisms for displaying, selecting, activating and linking tasks in projects, where such mechanisms can include display windows, dialog boxes, display buttons, pull-down menus, and selection buttons. At block 306, the facility creates in the unified graphical user-interface appropriate mechanisms for displaying, selecting, activating and linking data in data fields associated with tasks in projects, where such mechanisms can include display windows, dialog boxes, display buttons, pull-down menus, and selection buttons.

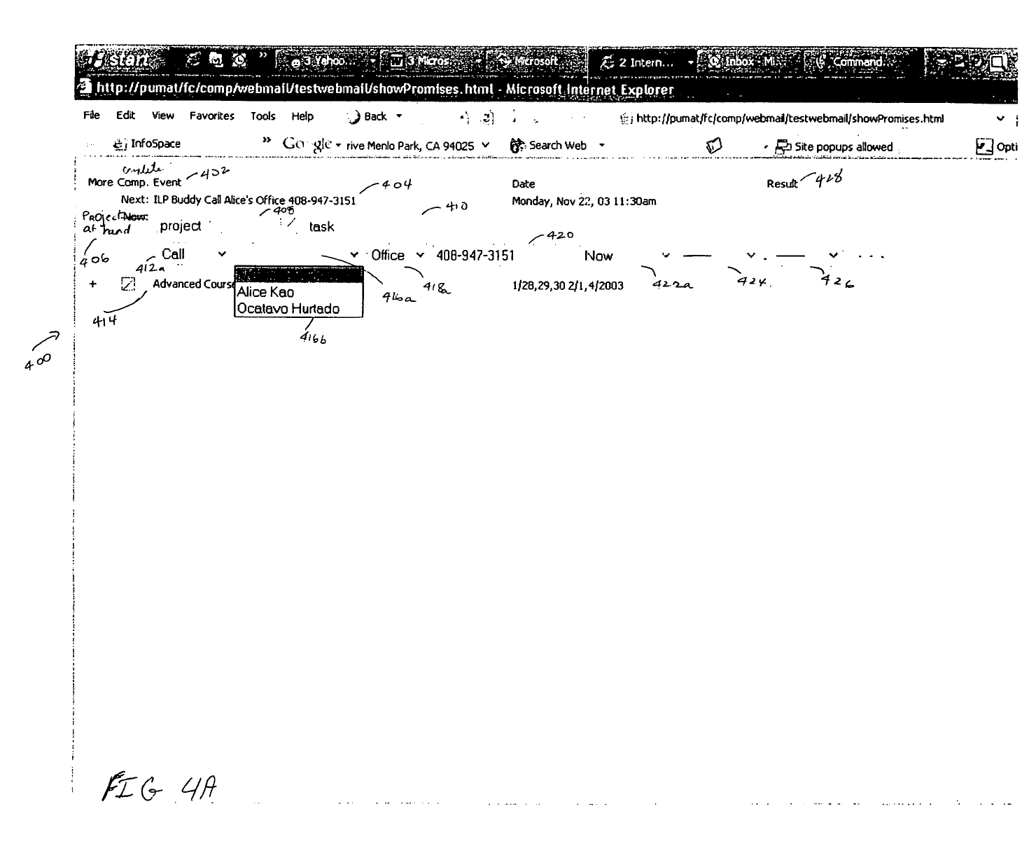

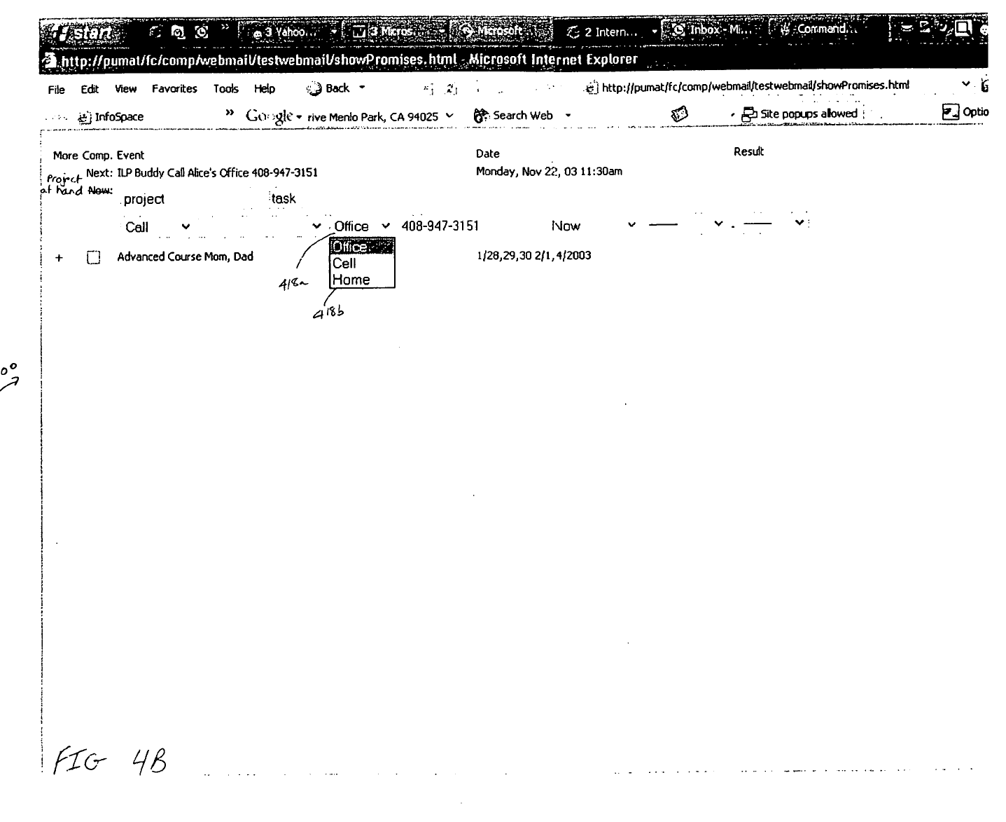

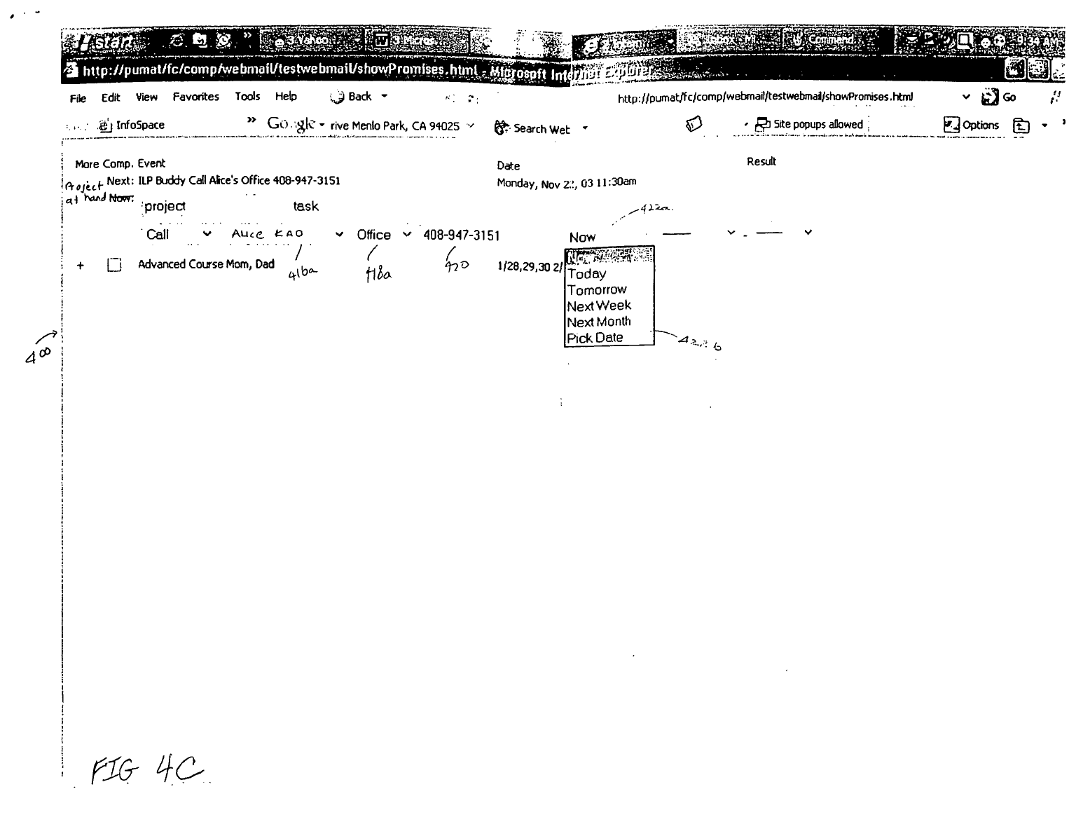

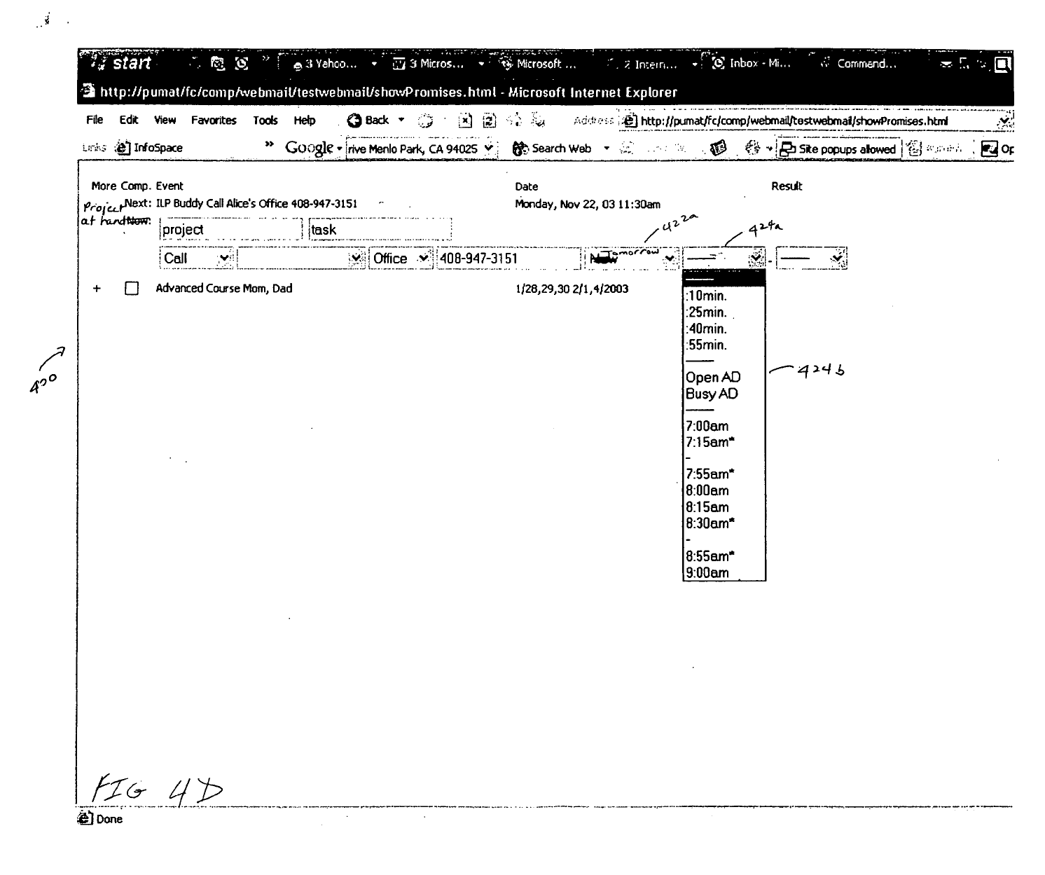

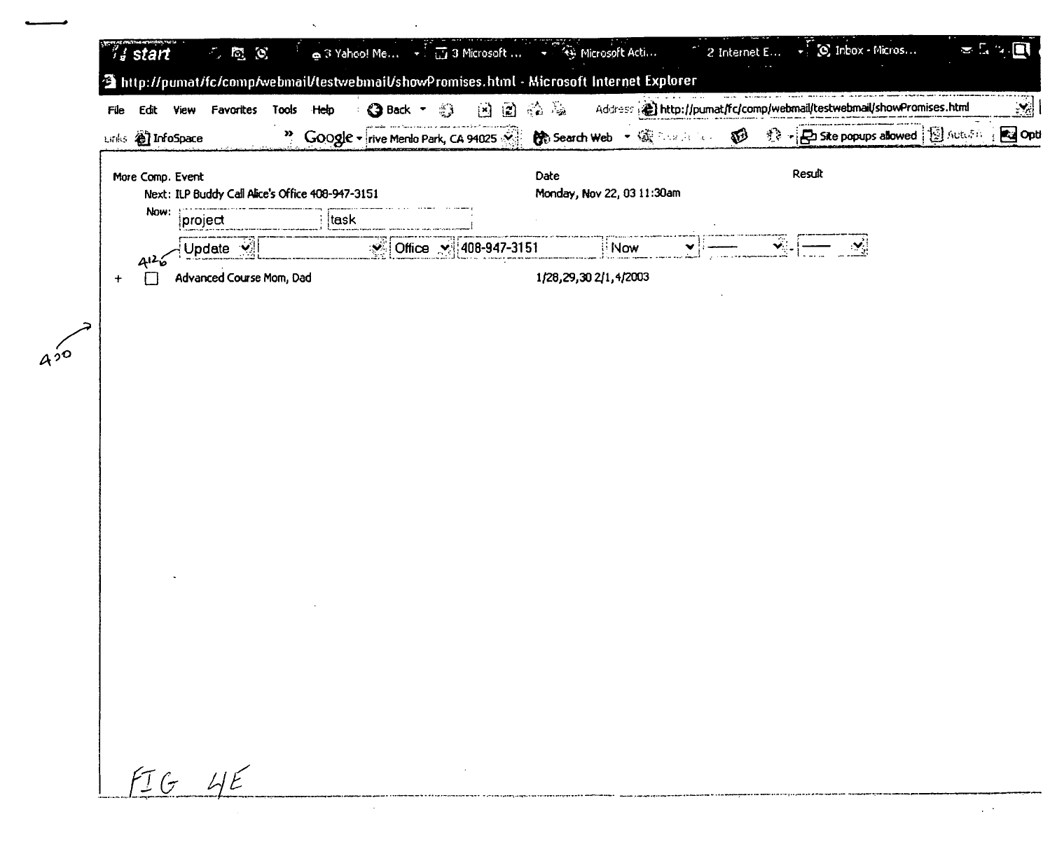

FIGS. 4A, 4B, 4C, 4D, and 4E are block diagrams that illustrate some of the features of the unified graphical user-interface, according to certain embodiments. In FIG. 4A, the unified graphical user-interface (unified GUI) 400 includes a column header line 402 to describe columns in unified GUI 400. Unified GUI 400 also includes a “project-at-hand” or “Now” designation line 406, a project GUI box 408, a task GUI box 410, a selected task GUI box 412a, a list of existing projects 414, a plurality of data field GUI boxes such as 416a, 418a, 420, 422a, 424, and 426. Region 428 in unified GUI 400 is used for displaying results of a task. In certain embodiments, a pop-up window may appear for making notes, or for displaying user-instructions related to the project. Unified GUI 400 is adapted for creating and displaying reports that are associated with a given project. Example of reports are status reports, financial reports, milestone reports, man-hour reports, etc.

For purposes of explanation of FIGS. 4A, 4B, 4C, 4D, and 4E, assume that the project at hand is “Develop New Business”. One of the tasks in the template of tasks for the project “Develop New Business” is to telephone persons (“contacts”) listed on a “leads-list”. The selected task GUI box 412a shows that the selected task is “call”, i.e., telephone. The type of GUI boxes will change depending on what task has been selected in task GUI box 412a. The number of GUI boxes depends on what task has been selected in task GUI box 412a. For, example, some tasks will require fewer GUI Boxes to be used while other tasks may require more GUI boxes.

As previously explained, the GUI boxes can be multi-purpose. For example, the GUI boxes: 1) can be used for searching by inputting a key-word search term in the GUI box, 2) can be used for inputting data, and/or modifying existing data, and 3) can have pull-down menus for listing data or for listing options and or functions. Thus, GUI box 416a can be used as a pull-down list to show all the contacts in the leads-list. Another example of a pull-down list is illustrated in FIG. 4B, where GUI box 418a has a pull-down list 418b showing the different types of telephone numbers, “office”, “cell” and “home” telephone, etc.

Further, the GUI box 416a can be used as a search box to find a particular contact. For example, the typing of the word “Kao” in GUI box 416a finds a match with the contact name “Alice Kao.”

If Alice Kao is selected in GUI box 416a, then, due to automatic data linking, the rest of the GUI boxes in unified GUI 400 can be used to access data that is associated with Alice Kao in the Contact application program. For example, the data (a telephone number, in this case) in GUI box 420 can be used to contact Alice Kao using contact information that is stored for Alice Kao. FIG. 4C shows that since “office” was selected in GUI box 418a, GUI box 420 is populated with Alice's office telephone number, i.e., “408-947-3151.” Further, GUI box 422a has a pull-down list 422a for selecting the time to telephone Alice Kao. For example, the caller can choose to telephone Alice Kao “Now”, “today”, “Tomorrow”, etc., (see FIG. 4C).

If the caller selects “Tomorrow” in GUI box 422a, as shown in FIG. 4D, then the user can use GUI box 424a to pick an available time slot. The data that appears in GUI box 424a is linked to the caller's online calendar application for accessing the caller's calendar. Thus, GUI box 424a can show the available time slots, such as the ones shown in pull-down list 424b, for the caller.

If the caller decides to call Alice Kao “now”, then the data associated with telephoning Alice Kao is linked to an automatic dial-up mechanism for telephoning Alice Kao. The Contact application program, the calendar application program, and the automatic dial-up application program are all linked to the data fields in the GUI boxes. As previously explained, the type of application programs that are used for executing the tasks in a project will depend on what task is currently selected to be performed. Further, such application programs can be commercially available third party applications that are integrated for seamless use in the unified approach to create and manage projects.

FIG. 4E shows another selected task “Update” in GUI box 412b. For example, assume that the caller received new information about Alice Kao, such as a new mobile phone number. The caller then select the task “update” in order to update the project data. In this case, Alice Kao's contact information is updated by adding Alice Kao's new mobile phone number is added to the contact information database. Once Alice Kao's new mobile phone number to the contact information database, all tasks that are to be performed using the unified GUI, and that use contact information, will see the updated contact information for Alice Kao.

The number of GUI boxes and their placement vary according to the task and project at hand, and further will vary from implementation to implementation.

Further, the unified GUI can include a “FastCommand/Find” GUI box. Such a FastCommand/Find can be used to execute the computer application programs that are incidental to the project at hand or to execute an operating system line command. For example, returning to the example of telephoning Alice Kao, assume that the caller decided that he would like to find out more information on Alice Kao's company, “Acme Company.” The caller could temporarily suspend the task of telephoning and perform an Internet search on Acme Company using the FastCommand/Find GUI box. In FIG. 4A, task GUI box 412a can also be used as a FastCommand/Find GUI box. In certain embodiments, unified GUI 400 may have a special GUI box for FastCommand/Find. Other uses of the FastCommand/Find feature can be to access a calculator application, or a facsimile application, or to perform a search, for example.

According to certain embodiments, certain users will be given control rights to create new projects, modify existing projects, de-activate projects and/or reactivate projects using the unified GUI described above. Further, certain users can define new data fields in the linked data of a given third party application that is linked to the unified GUI. For example, assume a user would like to create the project “birthday list”. The user can add a data field in the Contact application program for inputting birth dates. Thus, in the future, existing contacts in the contact list can be updated with birthday information. Similarly, when new contacts are added to the contact list in the contact application program, the new data field can be used to record birthday information, if such information is available. When a task, such as “find contacts who have a birthday today”, is selected, an appropriate search application program can be linked to the project data, to identify the contacts who have a birthday today.

Further, according to certain embodiments, control rights can be set such that: 1) only certain users can view all projects, 2) only certain users can modify data in projects, 3) only certain users can create tasks, 4) the number of visible data fields that a user can see depends on the user's control rights, 5) only certain users can modify some or all data fields.

According to certain embodiments, results and data that are received in response to a task performed using the unified GUI are automatically linked to the project data in the project-at-hand or in related projects. In other words, all tasks that need to use such results and/or received data will be automatically linked to such results and/or received data.

Further, the results or received data can act as an automatic trigger of a set of automated tasks to be performed based on one or more pre-determined sets of rules. An example of an automated task is to convert the results or received data as well as related data into project data that is associated with a project that is different than the project-at-hand, based on a pre-determined set of rules. A suitable rules engine can be used to determine whether the pre-determined set of rules are satisfied. For example, assume that the project-at-hand is “Develop New Business” project. Further assume that the user contacted, via email, is Mr. X who is on the leads-list. Assume that Mr. X responds by sending a reply-email that indicates he would like to be a customer. Thus, Mr. X's reply email message (received data) and all the relevant data associated with Mr. X, such as his contact information, is moved to the project, “New Customer.” The New Customer project will have a series of tasks associated with it.

Further, assume that Mr. X's reply email message has as attached document. The attached document is automatically linked to the project data of the project-at-hand. If Mr. X continues to send more email messages with updated versions of the attached document, then the updated version also become part of the project data, and the facility automatically tracks the version number of the attached document.

According to certain embodiments, another example of an automated task is to update the data fields using the latest information available. For example, a pre-determined set of rules may include parsing the signature portion of a received reply email to determine whether the parsed information, such as address and telephone number, matches the information in the contact application.

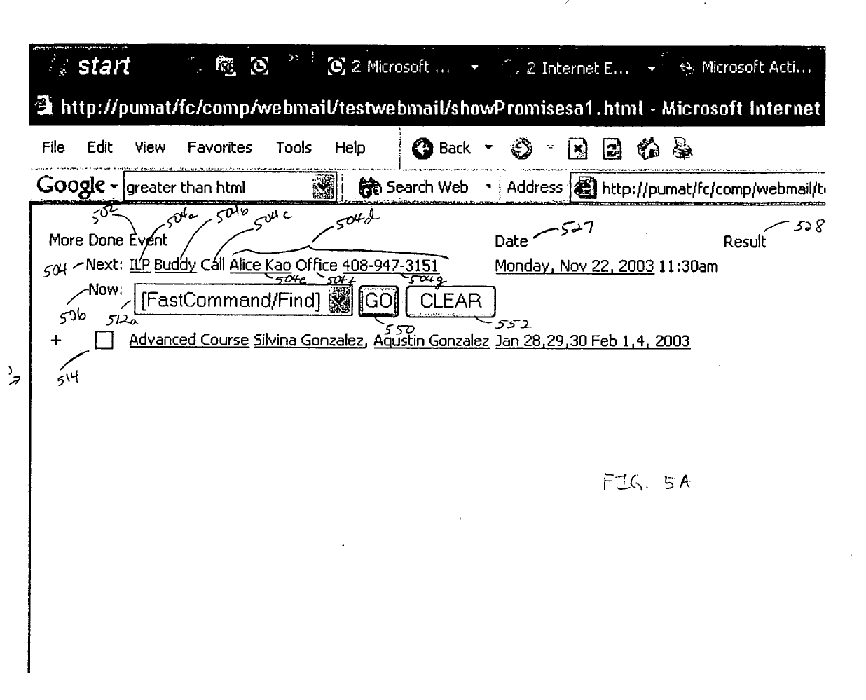

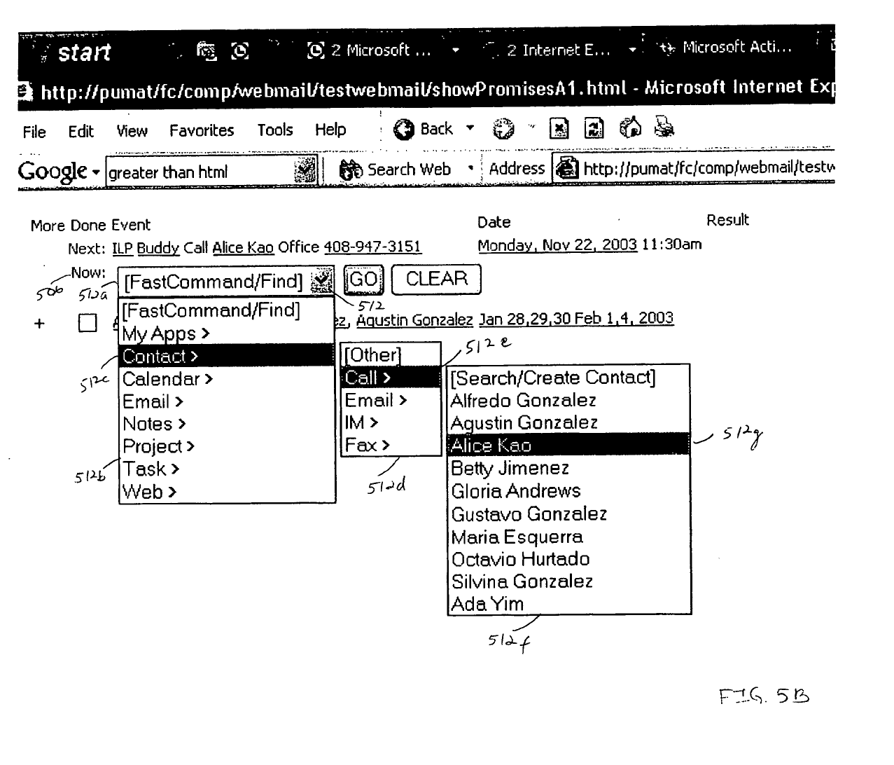

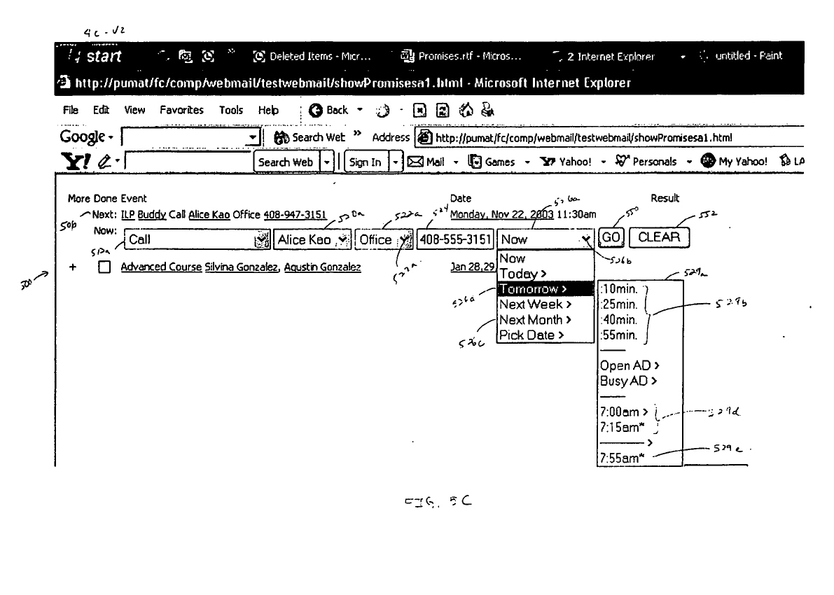

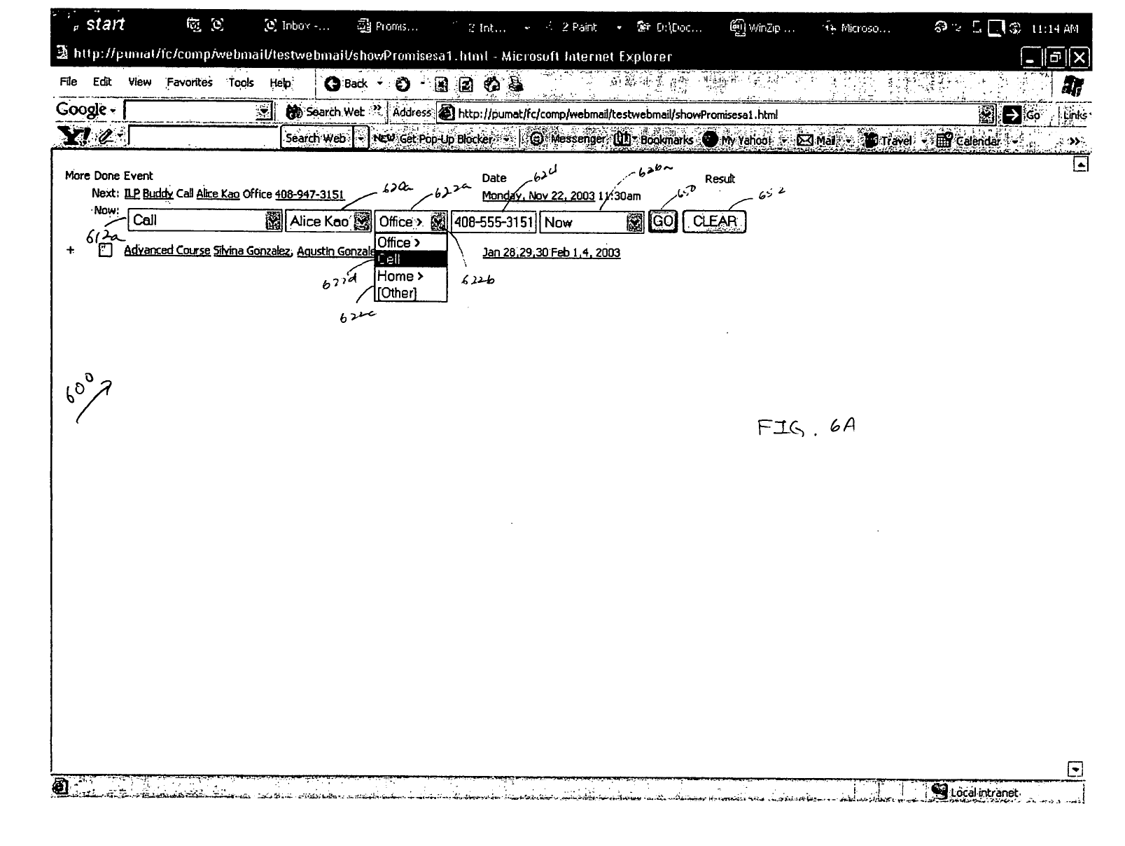

FIG. 5A is a block diagram that illustrates a unified graphical user-interface, according to certain embodiments. In FIG. 5A, the unified graphical user-interface (unified GUI) 500 includes a column header line 502 to describe columns in unified GUI 500. Unified GUI 500 also includes a “Next” task line 504 that indicates: 1) a next task 504c, 2) a project 504a that is associated with next task 504c, 3) a task template 504b, 3) task details 504d. Task details 504d includes data fields 504e, 504f and 504g. The number and type of data fields of task details 504d can vary depending on the nature of next task 504c. In the current example, data fields 504e, 504f and 504g are contact name (Alice Kao), type of phone number (Office), and phone number (408-947-3151).

In FIG. 5A, unified GUI 500 also includes a “project-at-hand” or “Now” designation line 506, date 527, list of project 514, and result 528. Result 528 is for displaying results of the task performed. In certain embodiments, a pop-up window may appear for making notes, or for displaying user-instructions related to the project.

The “Now” designation line 506 includes a Task/FastCommand/Find GUI box 512a, a GO button 550 and a CLEAR button 552. The Task/FastCommand/Find GUI box can be used to perform a search (FIND feature) or to execute computer application programs that are incidental to the project at hand or to execute an operating system line command (Fast Command feature). The GO button is for executing the selected task at hand, and the Clear button is to clear data fields in GUI 500. The number and type of GUI boxes or buttons on the “Now” designation line 506 can vary depending on the selected task at hand and may vary from implementation to implementation.

By clicking on any one of the fields such as, next task 504c, project 504a, task template 504b, task details 504d, the user can access the features and data associated with the “clicked” field. For example, if a user clicks on next task 504c in FIG. 5A, then the next task 504 becomes the “Now” task and will appear on GUI box 512a.

FIGS. 5B, 5C, 5D, and 5E are block diagrams that illustrate the creation of a task, according to certain embodiments. With reference to FIGS. 5B, 5C, and 5D, assume that User Q is attempting to create a task such as “call Alice Kao tomorrow at 8 a.m. for 25 minutes”. Such a task can be achieved as follows:
1) By clicking on the down-arrow 512 to access a pull-down menu 512b (see FIG. 5B).
2) By selecting the “contact” application 512c in pull-down menu 512b to reveal another pull-down menu 512d (see FIG. 5B).
3) By selecting “Call” function 512e from pull-down menu 512d to reveal yet another pull-down menu 512f (see FIG. 5B).
4) By selecting “Alice Kao” contact data 512g from down menu 512f (see FIG. 5B).
5) After “Alice Kao” contact data 512g is selected, unified GUI 500 shows “Call” in GUI box 512a, “Alice Kao” in GUI box 520a, “Office” in GUI box 522a, and Alice's telephone number in GUI box 524 (see FIG. 5C). According to certain embodiments, the facility automatically selects Alice's telephone number based on a history of User Q's telephone calls to Alice Kao. Of course, User Q can choose to call Alice Kao at a different telephone number by clicking on down-arrow 522a to select another phone number.
6) In FIG. 5C, at GUI box 526a, User Q can click on down-arrow 526b to show pull-down menu 526c in order to select the “tomorrow” time period 526d. When time period 526d is selected, another pull-down menu 529a appears for User Q to select a duration of time 529b. Pull-down menu 529a also shows the periods available, such as periods 529d, 529e, for calling Alice tomorrow. User Q can then select an available period from pull-down menu 529a.
7) After User Q selects the available period for calling Alice Kao, unified GUI 500 appears as shown in FIG. 5D. In FIG. 5D, unified GUI 500 shows “Call” in GUI box 512a, “Alice Kao” GUI box 520a, “Office” in GUI box 522a, Alice's office telephone number in GUI box 524, and tomorrow's available period (Tues, Nov. 23, 03, 8:00 am-8:25 am) in GUI box 526a. User Q can select the GO button 550 to add the task, “call Alice Kao tomorrow at 8 a.m. for 25 minutes.” Alternatively, User Q can select the CLEAR button 552 to create a new task if user Q decides not to create the task, “call Alice Kao tomorrow at 8 a.m. for 25 minutes.”

FIG. 5E is a block diagram that illustrates another way in which a task can be created, according to certain embodiments. For example, in FIG. 5E, user Q can simply input “Call Alice Tomorrow 8:00 am:25 min” in Task/FastCommand/Find box 512a and then selects the GO button 550.

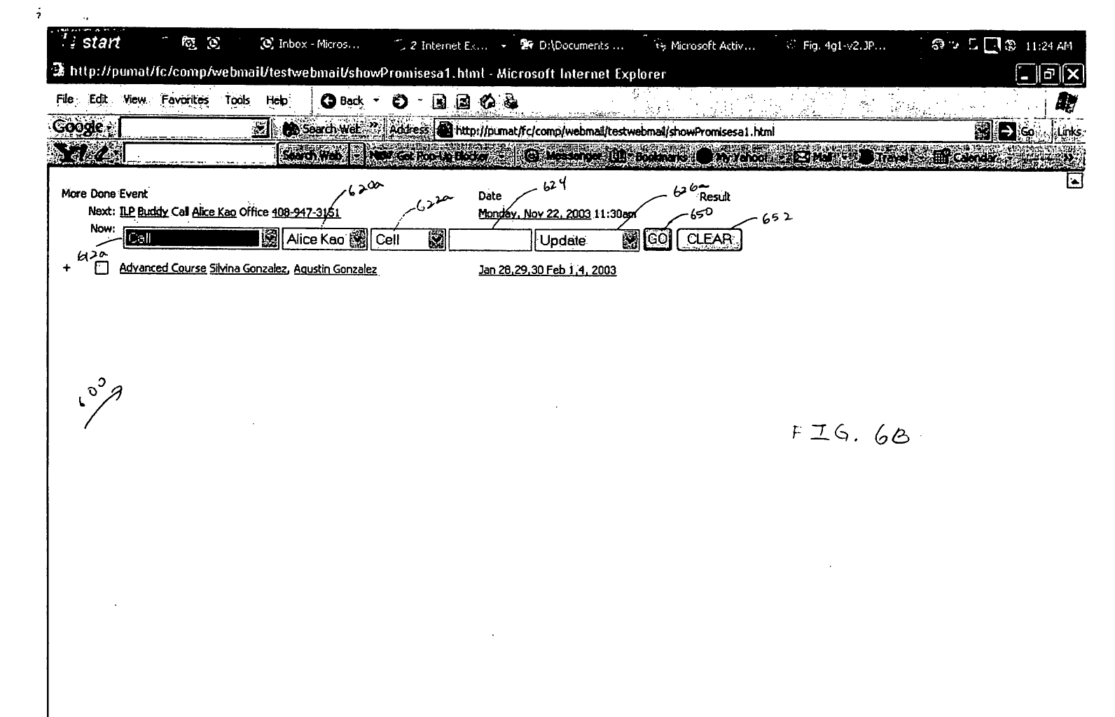

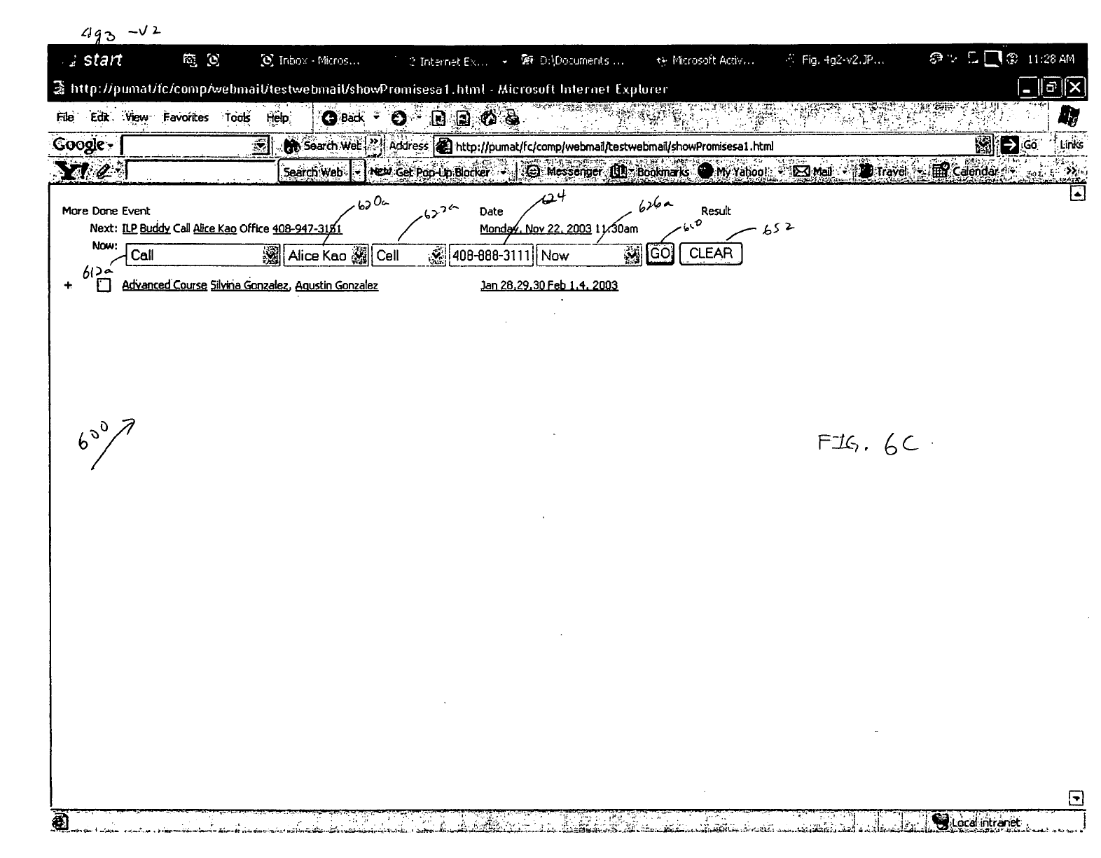

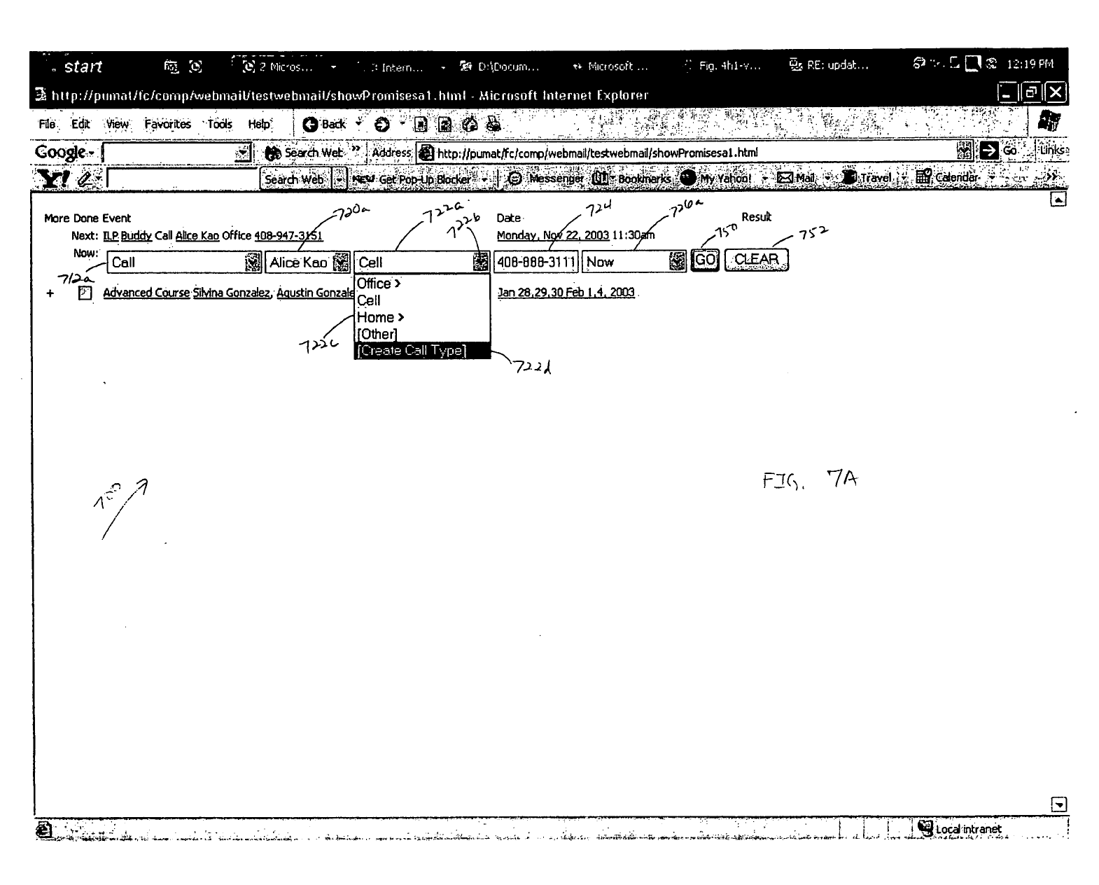

FIGS. 6A, 6B, and 6C, are block diagrams that illustrate the manner in which data in application programs can be updated using a unified graphical user-interface, according to certain embodiments. Unified GUI 600 shows the task “call” in GUI box 612a, and contact name “Alice Kao” in GUI box 620a. With reference to FIGS. 6A, 6B, and 6C, assume that User Q is attempting to update Alice Kao's contact information by adding her cell phone number in the Contact data base of the Contact application. Such a task can be achieved as follows:
1) By clicking on down-arrow 622b to show pull-down menu 622c in order to select “cell” type 622d. GUI box 624 shows Alice Kao's office telephone number and GUI box 626a shows “NOW” (see FIG. 6A).
2) After “cell” type 622d” is selected, “cell” is shown in GUI box 622a in FIG. 6B. User Q can then input the cell number in GUI box 624. GUI box 626a automatically shows “update” because the facility possesses context intelligence to know that user Q is updating Alice Kao's contact information.

3) In FIG. 6C, GUI box 626a automatically reverts to “Now”. User Q may now choose perform the task of calling Alice Kao using the newly inputted cell telephone by selecting the GO button 650.

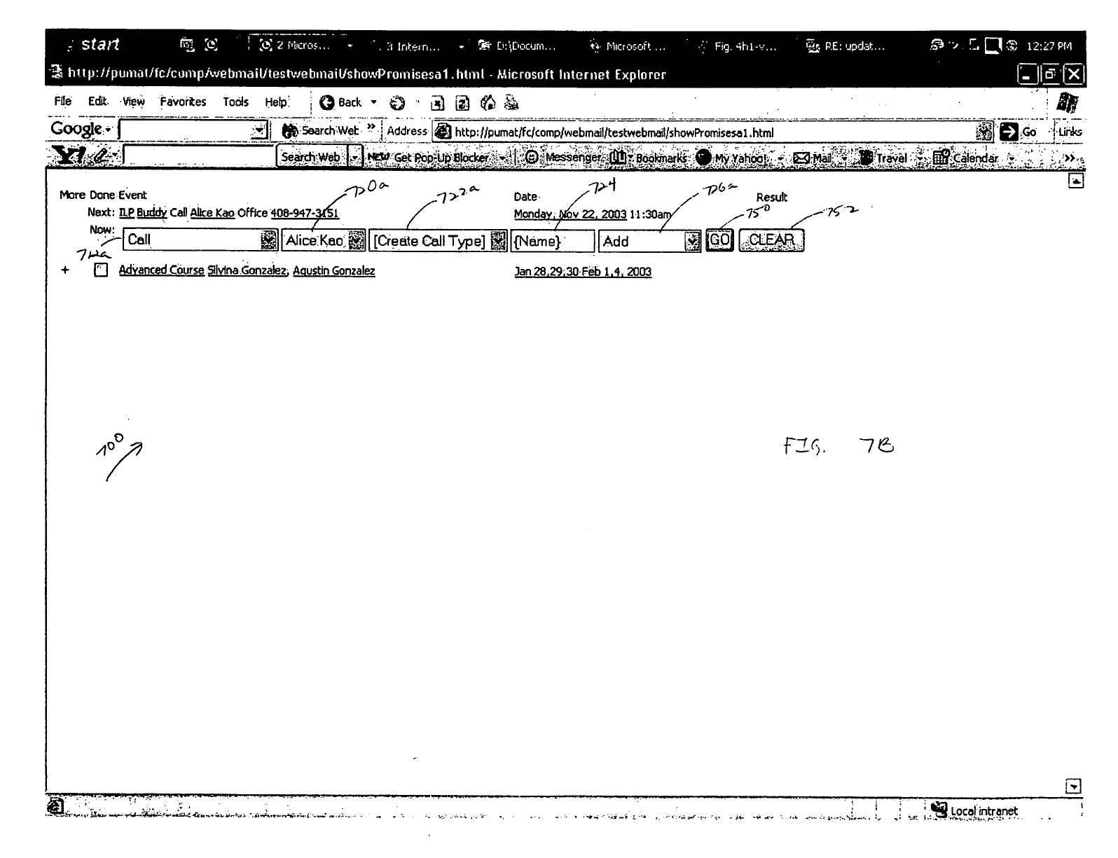

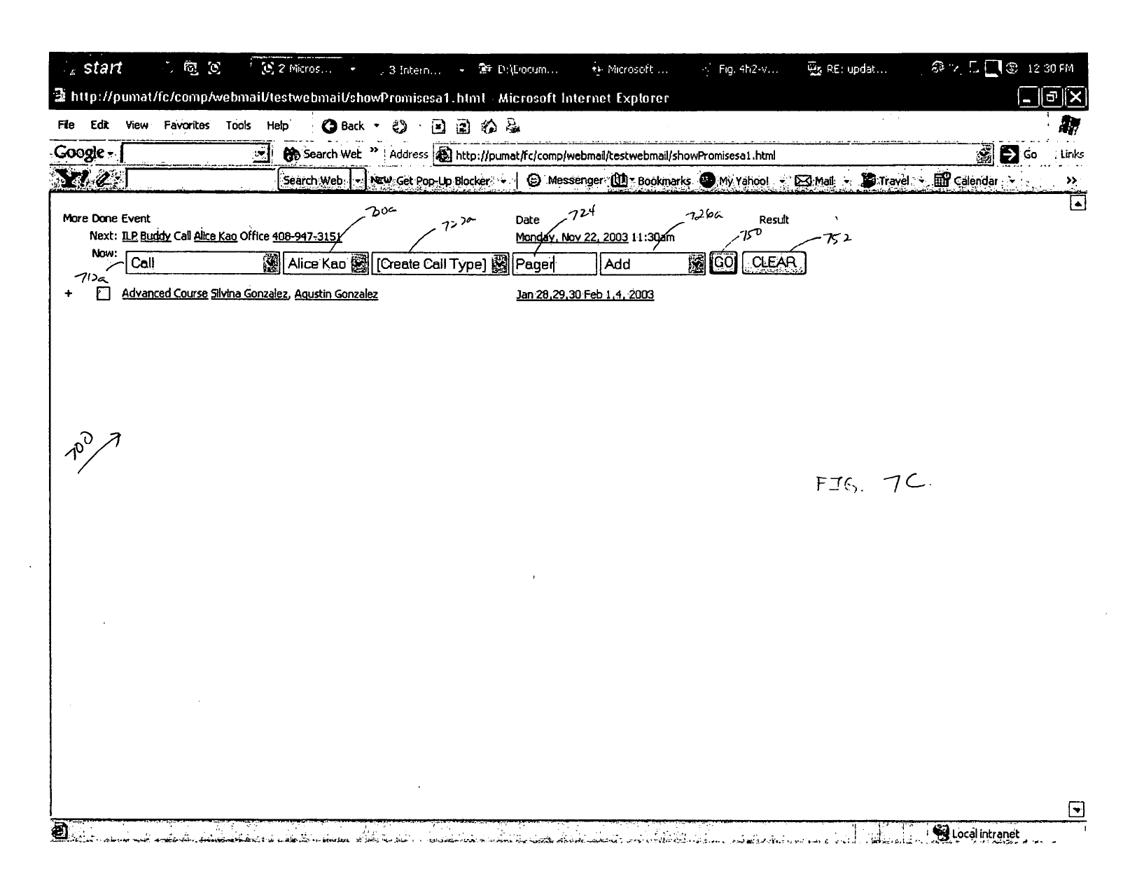

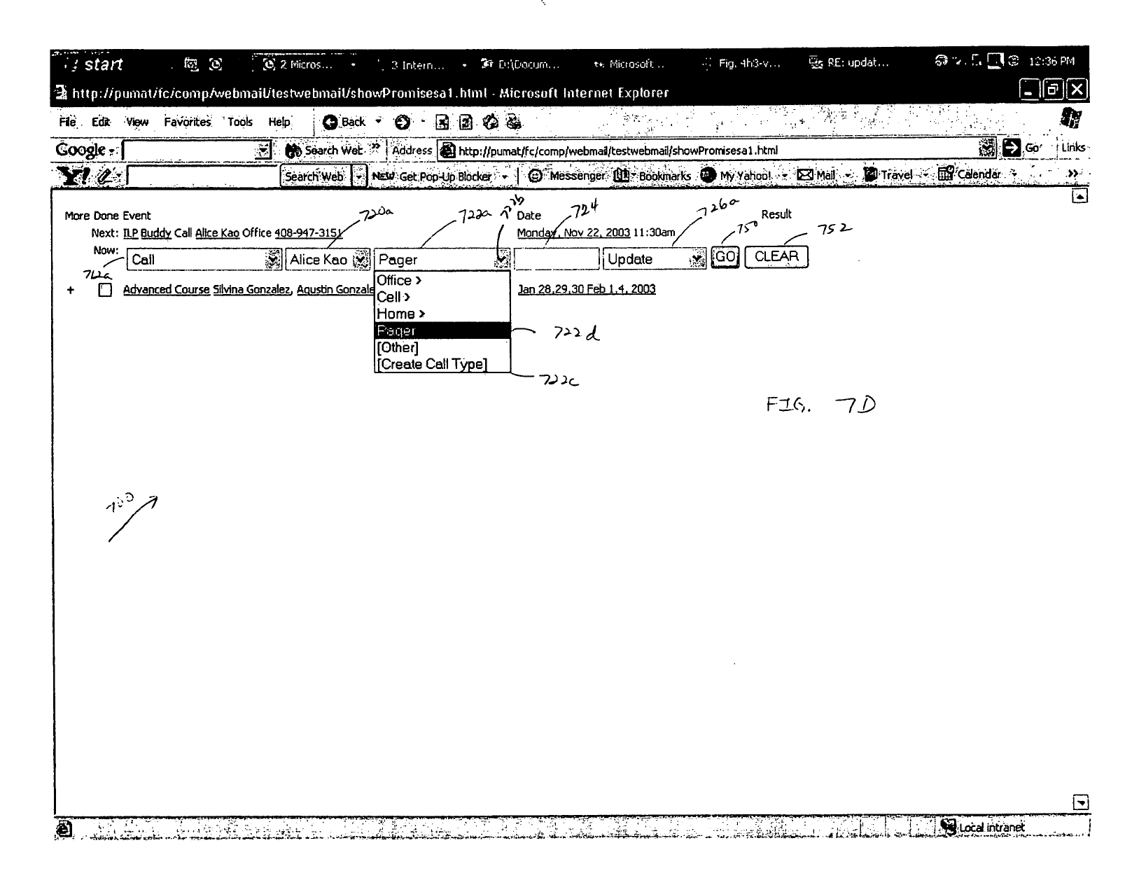

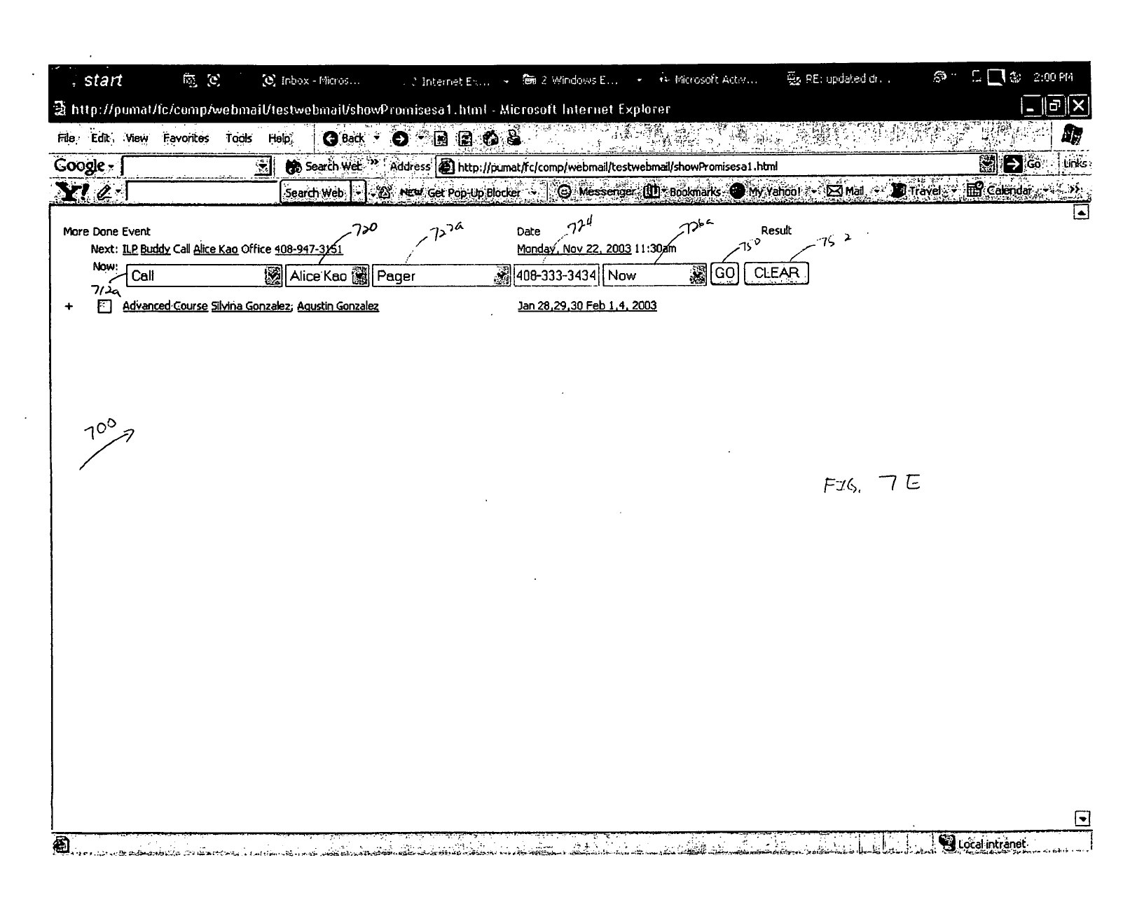

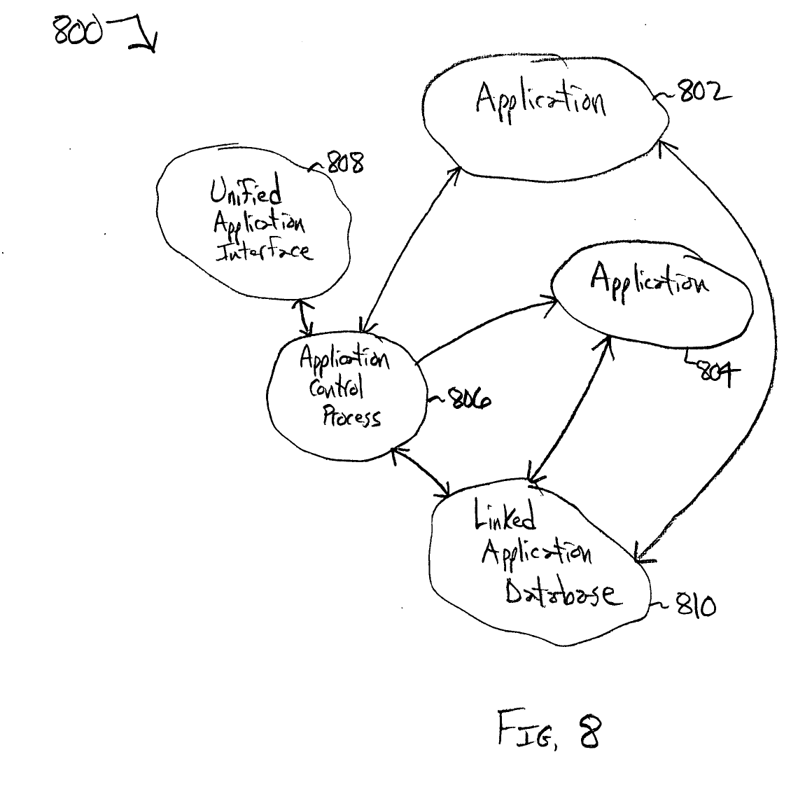

FIGS. 7A, 7B, 7C, 7D, and 7E are block diagrams that illustrate the creation of new data attributes associated with application programs using a unified graphical user-interface, according to certain embodiments. Unified GUI 700 shows task “call” in GUI box 712a, and contact name “Alice Kao” in Gui box 720a. With reference to FIGS. 7A, 7B, 7C, 7D, and 7E, assume that User Q is attempting to create the attribute or call type “pager” with respect to the Contact application. Further, assume that User Q possesses the control rights to add such an attribute. User Q can add a new attribute (a call type, for example) as follows:
1) By clicking on down-arrow 722b to show pull-down menu 722c in order to select “create call type” 722d as shown in FIG. 7A. GUI box 724 shows Alice Kao's cell telephone number and GUI box 726a shows “NOW” in FIG. 7A.
2) After “create call type” 722d is selected, “create call type” is shown in GUI box 722a as shown in FIG. 7B. Further, “name” is automatically shown in GUI box 724 and “Now” is automatically changed to “Add” in GUI Box 726a. User Q can then input the new call type in GUI box 724. GUI box 726a automatically shows “add” because the facility possesses context intelligence to know that user Q is creating a new attribute, i.e., a new call type, in this case.
3) User Q can input “pager” in GUI box 724, and then click on GUI box 626a to “add” pager as the new call type (see FIG. 7C).
4) As shown in FIG. 7D, User Q can click on down-arrow 722b to reveal pull-down menu 722c in order to select the “pager” call type 722d. The user can then input the pager number in GUI box 724. GUI box 726a automatically shows “update” because the facility possesses context intelligence to know that User Q is adding new information to Alice Kao's contact information.
5) In FIG. 7E, GUI box 726a automatically reverts to “Now”. User Q may now choose perform the task of calling Alice Kao using the newly inputted pager number by selecting the GO button 650.

Thus, the description of FIGS. 7A, 7B, 7C, 7D and 7E demonstrate the facility's programmatic intelligence for creating a new attribute such as new call type such as “pager number”. Thus, the facility links the newly created attribute or type across tasks within the project and across related projects so that such tasks and associated computer application programs share a unified view of the new attribute. Thus, reporting applications, logging application and dialing applications will then recognize the new call type, “pager number.” Also, the new call type is now an available option in the Contact application.

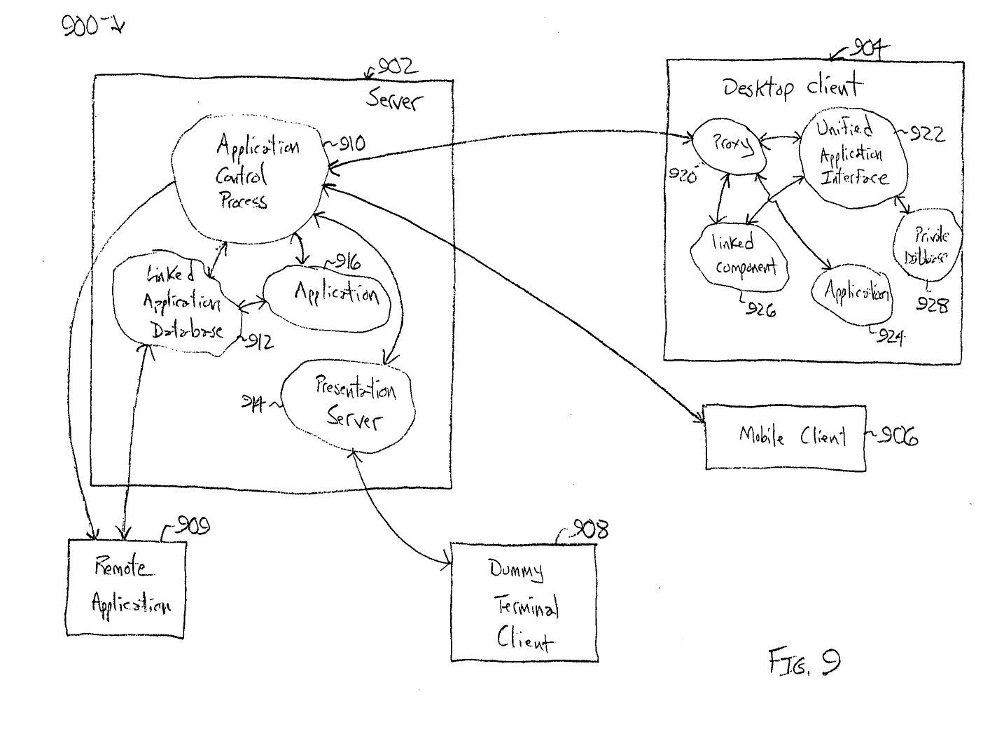

Turning next to FIG. 8, a computer system 800 in accordance with one embodiment of the present invention will now be described. As will be readily understood by those skilled in the art, FIG. 8 illustrates the computer system 800 at a level of abstraction signifying computer processes. The computer system 800 includes a plurality of applications 802 and 804, an application control process 806, a unified application interface 808, and a linked application database 810. The computer system 800 can be implemented in a variety of ways such as on a single computer (e.g., desktop implementation), or in a distributed fashion as described below in more detail with reference to FIG. 9.

The applications 802 and 804 represent applications the user has incorporated for use via a single interface, i.e., the unified application interface 808. As described above with reference to the earlier FIGS., these applications can be provided by third party vendors such as Microsoft, Corel, etc. Additionally, the present invention enables a user to access and program their own application logic under control of the unified application interface 808.

The application control process 806, the unified application interface, and the linked application database 810, work together to delegate data and instructions received from the user to applications for processing. By this process, data and logic of the plurality of applications 802 and 804 is available to the user through the unified application interface 808. This allows the user to have a unified approach to access and control all applications available within the computer system 800. Note that this access and control is done independent of the interfaces provided by the applications.

Certain embodiments of the present invention also allow the user to access the native application interfaces through a native application window opened inside the unified application interface 808 and under control of the application control process 806. This allows the user to unify certain applications, and still have access to the native interfaces of other applications, all within one unified application interface. By keeping the native interfaces under control of the control application process 806, the computer system 800 is capable of tracking usage and controlling access rights, among other things.

The linked application database 810 stores and manages data, access rights, historical tracking information, etc., with reference to the plurality of applications, in order to enhance, combine, and link data found in the plurality of applications. Access and management of the linked application database 810 is controlled by the application control process 806. The application control process 806 is context sensitive and programmable by the user. Although the process 806-810 are illustrated as separate entities, these components may be combined logically and/or may be distributed across different computing platforms.

As mentioned, the computer system 800 of FIG. 8 can be implemented as distributed system. One possible distributed system 900 will now be described in more detail with reference to FIG. 9. The system 900 includes a server computer 902, a plurality of distributed clients such as a desktop computer 904, a mobile device 906, and a dummy terminal 908, and a plurality of remote applications 909.

The server computer 902 includes an application control process 910, an application linked database 912, a presentation server 914, and a plurality of applications such as application 916. The desktop computer 904 includes a proxy 920 for the application control process 910, a unified application interface 922, a distributed component 924 of the linked application database 912, a plurality of applications such as application 926, and a private database 928. The mobile phone client 906 is similar to the desktop client 902 and will not be described in further detail.

Operation of the computer system 900 is much like that described above with reference to FIG. 8, however there are additional mechanisms involved to effectuate the distributed nature of the system 900. The mechanisms involved in effectuating a distributed system will be readily appreciated by those skilled in the art. For example, the proxy 920 operates locally to make the processing of the remote application control process 910 available on the client 904. The component 924 is synchronized with the linked application database 912. Remote applications 909 are made available to the plurality of clients through the application process control 910 or the linked application database 912 residing on the server computer 902. The private database 928 is characterized by having access rights controlled locally at the client 904. This provides the local user the ability to share private data with third-parties as desired.

The client 908 is a dummy terminal, web browser such as a Citrix client, Rich Internet Application, etc. The interface process 914 presents a unified application interface to a user of the client 908, which interface is a portal to the server computer 902. This provides a user of the client 908 access to all the distributed applications and data available across the system 900 through a unified application interface.

It will be appreciated by those skilled in the art that the above-described facility may be straightforwardly adapted or extended in various ways.

In the foregoing specification, embodiments of the invention have been described with reference to numerous specific details that may vary from implementation to implementation. Thus, the sole and exclusive indicator of what the invention is and what is intended by the applicants to be the invention, is the set of claims that issue from this application, in the specific form in which such claims issue, including any subsequent correction. Any express definitions set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method for using and creating a plurality of applications within a unified application environment, the method comprising:
creating one application that includes a graphical user-interface;
wherein said one application is adapted for using and managing said plurality of applications through said graphical user-interface; and
wherein said graphical user-interface is the only user-interface seen by a user and obviates the use of individual graphical user-interfaces that are associated with any one of said plurality of applications.

2. A computer system suitable for controlling a plurality of applications, said computer system comprising:
a unified application interface enabling a user to access data and logic from a plurality of applications via said unified application interface;
an application control process operable to implement instructions received from said user via said unified application interface, said application control process delegating instructions received from said user to a suitable one of said plurality of applications, whereby said user is able to utilize logic and data of said applications through said unified application interface rather than through native interfaces of said plurality of applications;
a linked application database for maintaining data provided by said plurality of applications, access and management of said linked application database controlled by said application control process; and
wherein said unified application interface, said application control process, and said linked application database are context sensitive and are programmable via said unified application interface.

3. A computer system as recited in claim 38, wherein said application control process populates said linked application database with data and linking information related to said plurality of applications.

4. A computer system as recited in claim 38, wherein said application control process is capable of opening within said unified application interface a native interface associated with a one of said plurality of applications.

5. A computer system as recited in claim 38, wherein said unified application interface process and said application control process are a single logical unit.

6. A computer system as recited in claim 38, wherein said plurality of applications are distributed across a plurality of computers.

7. A computer system suitable for providing a plurality of clients access to a plurality of distributed applications, each client having a unified application interface:
at least one client computer including:
a unified application interface enabling a user to access data and logic from a plurality of distributed applications via said unified application interface;
a proxy for an application control process located on a server, said proxy coupled to said unified application interface; and
a linked database component under control of said application control process;
said server computer including:
said application control process operable to implement instructions received from said plurality of users, said application control process delegating instructions received from said users to a suitable one of said plurality of distributed applications, said application control process coupled to said proxy; and
a linked application database controlled by said application control process, said linked application database synchronized with said linked database component; and
a network coupling said at least one client computer and said server computer.

8. A computer system as recited in claim 43, wherein said proxy and said application control process are components of a peer-to-peer system.

9. A computer system as recited in claim 43, wherein said at least one client includes a private database having access rights controlled by said at least one client.

10. A computer system for providing network services to a plurality of clients, said computer system comprising:
a server computer including:
an application control process operable to implement instructions received from a plurality of users, said application control process delegating instructions received from said users to a suitable one of a plurality of distributed applications;
a linked application database controlled by said application control process, said linked application storing data and accessible to said plurality of distributed applications;
a presentation server operable to provide a unified application interface to a remote client;
said remote client capable of generating a display window provided by said presentation server; and
a coupling between said server computer and said remote client.

11. A computer system as recited in claim 46, wherein said remote client is a dummy computer terminal.

12. A computer system as recited in claim 46, wherein said remote client is a Rich Internet Application.

13. A computer system as recited in claim 46, wherein said remote client is a Citrix client.

14. A method in a computing system for enabling a plurality of projects, the method comprising:
creating a unified user-interface for defining a template comprising one or more tasks for at least one project from said plurality of projects;
defining project data that is associated with said at least one project;
linking said project data such that said one or more tasks associated with said at least one project and other tasks associated with related projects share a unified view of said project data;
adapting said unified user-interface to allow:
display and selection of said at least one project;
display of and selection for performing said one or more tasks from said template; and
display and selection of one or more data fields that are based on said selected task and that are associated with one more application programs used for performing said selected task; and
wherein said unified user-interface is adapted for automatically executing said one or more computer application programs for performing said selected task.

15. The method of claim 1, wherein adapting said unified user-interface to allow display and selection further comprises using one or more multipurpose GUI boxes that can be used for:
performing a search;
inputting data;
listing data;
listing options; and
listing functions.

16. The method of claim 1, wherein said unified user-interface is further adapted to allow display of results from completion of said selected task.

17. The method of claim 1, further comprising:
developing rule sets for managing project data.

18. The method of claim 4, wherein said rule sets include rules for:
parsing information in received data for purposes of updating project data, wherein said received data is received in response to said one or more tasks in said at least one project.

19. The method of claim 4, wherein said rule sets include rules for:
parsing information in received data for purposes of determining with which project said received data is to be associated.

20. The method of claim 4, wherein said rule sets include rules for:
storing received data in a manner such that said received data is associated with said at least one project, wherein said received data is received in response to said one or more tasks in said at least one project.

21. The method of claim 1, further comprising:
re-designating one or more components of said project data to a pre-determined different project when a pre-determined set of project-designation rules are satisfied.

22. The method of claim 1, wherein linking further comprises:
triggering performance of one or more of said other tasks associated with said related projects.

23. The method of claim 1, wherein performing said selected task includes at least one of:
receiving received data wherein said received data is received in response to performing said one or more tasks and is automatically integrated into said project data; and
modifying one or more values corresponding to said one or more data fields associated with said application programs.

24. The method of claim 1, wherein said unified user-interface is further adapted for allowing display and selection for execution of:
one or more operating system commands; and
one or more external computer application programs that are incidental to performing said selected task.

25. The method of claim 11, wherein said one or more external computer application programs include:
a facsimile application program;
a telephone application program;
a web access application program; and
a calculator application program.

26. The method of claim 1, wherein said unified user-interface is further adapted for displaying a next calendared event.

27. The method of claim 13, wherein said next calendared event is associated with one of said plurality of projects.

28. The method of claim 13, wherein said next calendared event is independent of said plurality of projects.

29. The method of claim 1, wherein said data fields includes a status data field for designating a status of said project.

30. The method of claim 1, wherein said unified user-interface displays task instructions for performing said selected task.

31. The method of claim 1, wherein said unified user-interface is adapted for displaying project description and global instructions.

32. The method of claim 1, wherein said unified user-interface selectively displays said one or more data fields based on access and control rights of a user who is using said interface.

33. The method of claim 1, further comprising defining access and control rights associated with said plurality of projects.

34. The method of claim 1, further comprising defining access and control rights associated with said one or more data fields.

35. The method of claim 1, further comprising defining access and control rights for creating any new projects.

36. The method of claim 1, further comprising defining access and control rights for creating any new tasks.

37. The method of claim 1, further comprising defining access and control rights for modifying said plurality of projects.

38. The method of claim 1, further comprising defining access and control rights for modifying said one or more tasks.

39. The method of claim 1, wherein said one or more data fields are adapted to being de-activated or re-activated by a user.

40. The method of claim 1, further comprising creating default values for said one or more data fields.

41. The method of claim 1, wherein said one or more computer application programs and said one or more data fields are accessed via the Internet.

42. A computer-readable medium carrying one or more sequences of instructions for managing employee data, wherein execution of the one or more sequences of instructions by one or more processors causes the one or more processors to perform:
extracting employee position management information in a first form that is associated with a first source computerized employee position management system;
converting the employee position management information in the first form into employee position management information that is in a second intermediate form; and
converting the employee position management information in the second intermediate form into employee position management information in a target form that corresponds to a target computerized employee position management system.
